(19) United States
(12) Patent Application Publication
(10) Pub. No.: US 2007/0230449 A1
(43) Pub. Date: Oct. 4, 2007

(54) Telephone system and telephone terminal apparatus

(75) Inventor: Satoshi Arai, Hamura-shi (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Toshiba America Information Systems, Inc.

(21) Appl. No.: 11/700,337

(22) Filed: Jan. 30, 2007

(30) Foreign Application Priority Data
Mar. 31, 2006 (JP) 2006-099132

(51) Int. Cl. H04L 12/66

(52) U.S. Cl. 370/352

(57) ABSTRACT

According to one embodiment, a telephone system includes a first telephone terminal and a second telephone terminal, wherein the first telephone terminal includes an acquisition unit to selectively acquire arbitrary music data from among a plurality of different music data, a request transmitter which transmits a reception request for the music data to the second telephone terminal via the communication network, when the music data is acquired; and a data transmitter which transmits the music data to the second telephone terminal via the communication network, when a response to transmission of the reception request is returned from the second telephone terminal, and the second telephone terminal includes a reproducer which reproduces as sound the voice data sent from the first telephone terminal, when a reception request for the music data has arrived from the first telephone terminal via the communication network.

### CROSS-REFERENCE TO RELATED APPLICATIONS

This application is based upon and claims the benefit of priority from the prior Japanese Patent Application No. 2006-99132, filed Mar. 31, 2006, the entire contents of which are incorporated herein by reference.

### BACKGROUND

1. Field

One embodiment of the present invention relates to a telephone system provided with a function to perform transmission of voice data and background music (BGM) data in, for example, an Internet protocol (IP) telephone system and a telephone terminal apparatus for use in the telephone system.

2. Description of the Related Art

Recently, a network telephone system (IP telephone system) is starting to be used widely which performs real-time bi-directional transmission and reception of an image and a voice as packet data via a packet network. In the IP telephone system, by accommodating a plurality of IP telephone terminals in an IP network such as a local area network (LAN) or the Internet and connecting the IP network to a public network via a gateway so that the gateway performs address translation or the like, multimedia information communication is made possible between the IP telephone terminals and between the IP telephone network and the public network.

Such an IP telephone system is strongly desired to provide supplementary services other than a call. The additive services may include, for example, an information delivery service, by which a user can download data such as music pieces or images from a server provided on the IP network, to his/her IP telephone terminal.

However, according to the information delivery service, the IP telephone terminal cannot download a desired music piece during a call. Further, a method is available by which a user may bring a sound source such as a compact disk (CD) player close to a microphone so that a call partner can hear music data reproduced from this sound source. In this case, however, the call partner will hear poor-quality music.

Also, a conventional method is available by which a user at an IP telephone terminal may receive from his/her partner transmission source information indicative of a transmission source of an audible content such as a radio broadcast program, and based on the transmission source information, access a transmission source by any reception means other than an audio signal to thereby output the audible content separately from a call sound (see, for example, Jpn. Pat. Appln. KOKAI Publication No. 2004-194057).

According to this method, reception means other than audio signal reception means must be set to the IP telephone terminal, thus resulting in a complicated and hence large-scale configuration of the IP telephone terminal.

### BRIEF DESCRIPTION OF THE SEVERAL VIEWS OF THE DRAWING

A general architecture that implements the various feature of the invention will now be described with reference to the drawings. The drawings and the associated descriptions are provided to illustrate embodiments of the invention and not to limit the scope of the invention.

FIG. 1 is a schematic diagram showing a configuration of an IP telephone system in a first embodiment of the present invention;

FIG. 2 is a perspective view of a configuration of an IP telephone set shown in FIG. 1;

FIG. 3 is a block diagram showing a functional configuration of the IP telephone set shown in FIG. 1;

FIG. 4 is a perspective view of one example of a peripheral device connectable to the IP telephone set shown in FIG. 1;

FIG. 5 is a schematic sequence diagram showing operations to transmit and receive information among the IP telephone set, a main apparatus, and a BGM server in the first embodiment;

FIG. 6 is a structure view of a router shown in FIG. 1;

FIG. 7 is a schematic diagram showing a configuration of an IP telephone system in a second embodiment of the present invention;

FIG. 8 is a schematic sequence diagram showing operations to transmit and receive information between the IP telephone set and a main apparatus in the second embodiment;

FIG. 9 is a schematic diagram showing a configuration of an IP telephone system in a third embodiment of the present invention;

FIG. 10 is an explanatory diagram of processing to mix voice data and BGM data in an IP telephone set in the third embodiment;

FIG. 11 is a schematic diagram showing a configuration of an IP telephone system in a fourth embodiment of the present invention;

FIG. 12 is an explanatory diagram of processing to mix voice data and BGM data in an IP telephone set in the fourth embodiment;

FIG. 13 is a schematic diagram showing a configuration of an IP telephone system in a fifth embodiment of the present invention;

FIG. 14 is a schematic diagram showing a configuration of an IP telephone system in a sixth embodiment of the present invention;

FIG. 15 is an explanatory diagram of an example of performing analog mixing processing on a voice and BGM in the first and second embodiments of the present invention; and

FIG. 16 is an explanatory block diagram of an example of performing digital mixing processing on a voice and BGM in the first and second embodiments of the present invention.

### DETAILED DESCRIPTION

Various embodiments according to the invention will be described hereinafter with reference to the accompanying drawings, In general, according to one embodiment of the invention, a telephone system which performs communication by establishing communication connection between a first telephone terminal and a second telephone terminal of a plurality of telephone terminals connected to a communication network over which a voice packet is transmitted, wherein the first telephone terminal comprises: an acquisition unit to selectively acquire arbitrary music data from among a plurality of different music data; a request transmitter which transmits a reception request for the music data to the second telephone terminal via the communication network, when the music data is acquired; and a data transmitter which transmits the music data to the second telephone terminal via the communication network, when a response to transmission of the reception request is returned from the second telephone terminal; and the second telephone terminal comprises a reproducer which reproduces as sound the voice data sent from the first telephone terminal, when a reception request for the music data has arrived from the first telephone terminal via the communication network.

### First Embodiment

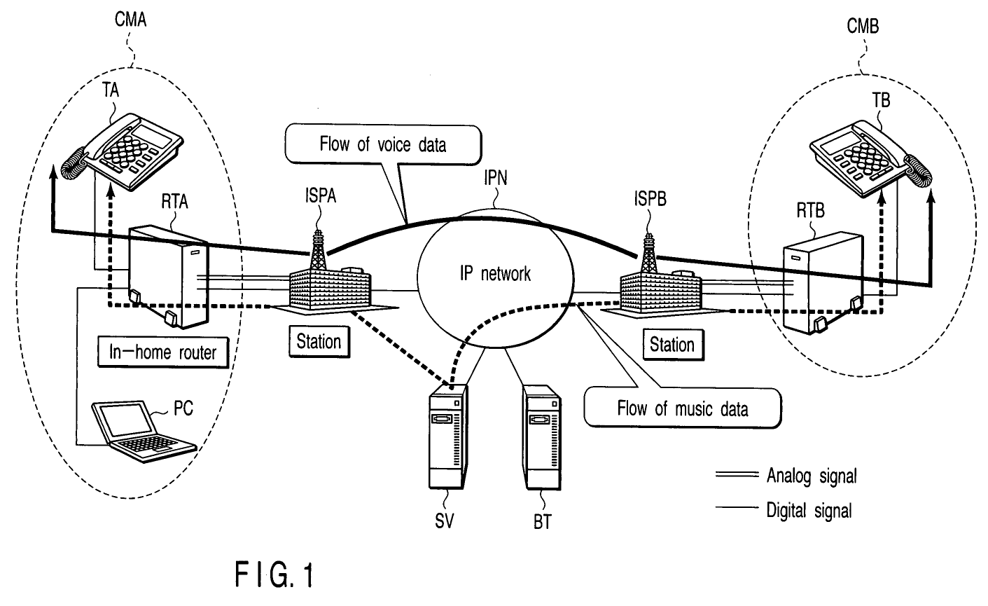

FIG. 1 is a schematic diagram showing a configuration of an IP telephone system in a first embodiment of the present invention, in which CMA and CMB indicate a user system, BT indicates a session initiation protocol (SIP) server, and SV indicates a BGM server.

The user system CMA comprises an IP telephone set TA, a personal computer PC, and a router RTA.

The IP telephone set TA and the personal computer PC are connected via the router RTA and a station ISPA to an IP network IPN, which IP network IPN is further connected to a station ISPB, the SIP server BT, and the BGM server SV.

The user system CMB comprises an IP telephone set TB and a router RTB. The IP telephone set TB is connected via the router RTB and a station ISPB to the IP network IPN, which IP network IPN is further connected to the station ISPA, the SIP server BT, and the BGM server SV.

The SIP server BT has a function to switch and connect between the IP telephone set TA and the IP telephone set TB in response to an incoming/outgoing call.

The BGM server SV is intended to deliver BGM data in response to a request from the user systems CMA and CMB.

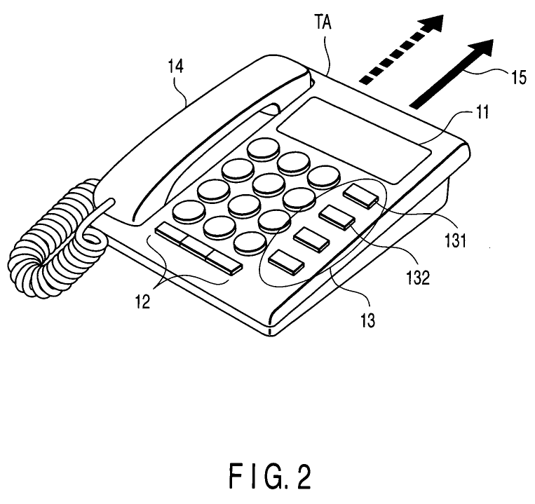

FIG. 2 is an external view of the above-described IP telephone sets TA and TB. The IP telephone set TA is used as a representative in the following description.

On a front panel portion of the IP telephone set TA, a display unit 11 constituted of an LCD is arranged, and on a lower panel portion of the display unit 11, dial keys 12 and control keys 13 for controlling start, stop, and pause of BGM playback respectively are arranged. The control keys 13 comprise a BGM insertion button 131 and a mixing button 132.

The BGM button 131, when pressed, operates to connect BGM. A BGM connection state is indicated by a lighting color of the button. The mixing button 132, when pressed, mixes BGM with a voice.

Further, on the left side of the front panel portion of the IP telephone set TA in the figure, a handset 14 is arranged which comprises a speaker and a microphone. The IP telephone set TA is further equipped with a connector 15 for connecting to the router RTA.

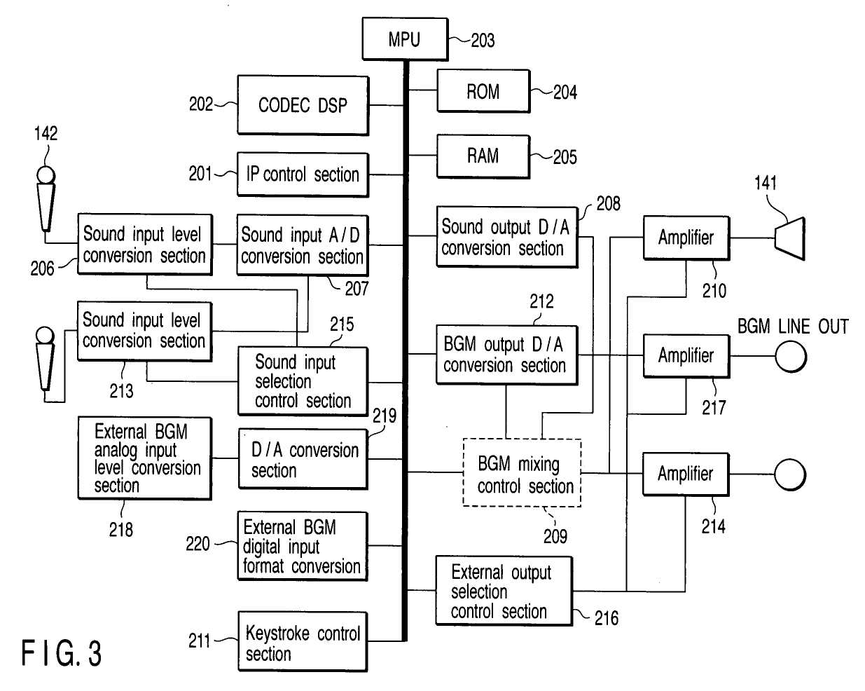

On the other hand, the IP telephone set TA has the following circuit configuration. FIG. 3 is a block diagram showing the configuration.

As shown in the figure, as basic functions, the IP telephone set TA comprises a network control section 201, a CODEC digital signal processor (DSP) 202, an MPU 203, a ROM 204, a RAM 205, a voice input level conversion section 206, a voice input A/D conversion section 207, a voice output D/A conversion section 208, a BGM mixing control section 209, an amplifier 210, and a keystroke control section 211.

The network control section 201 performs interface processing related to the IP network IPN connected via the router RTA. That is, the network control section 201 extracts voice data and control data from a transmission packet sent from the IP network IPN and gives the voice data to the CODEC DSP 202 and the control data to the MPU 203.

Further, if one BGM IP telephone terminal is connected with another BGM IP telephone terminal, the network control section 201 transmits voice data given from the CODEC DSP 202 to voice connection on the IP network IPN and transmits BGM data to a BGM connection. Note that if one BGM IP telephone terminal is connected with a non-BGM IP telephone terminal, the network control section 201 combines BGM data and voice data given by the CODEC DSP 202 and transmits the combined data to the voice connection on the IP network IPN.

The CODEC DSP 202 provides voice data given by the network control section 201 to the voice output D/A conversion section 208. Then, the voice data is converted into an analog audio signal by the voice output D/A conversion section 208. The converted signal in turn passes through the BGM mixing control section 209 and enters the amplifier 210 to be amplified to a predetermined level and is output loudly as a voice from a speaker 141 of the handset 14.

On the other hand, a message-transmission audio signal input from a microphone 142 of the handset 14 passes through the voice input level conversion section 206 and is converted into voice data by the voice input A/D conversion section 207 and provided to the CODEC DSP 202. The CODEC DSP 202 provides the voice data from the voice input A/D conversion section 207 to the IP control section 201.

Further, the CODEC DSP 202 provides BGM data from the IP control section 201 to a BGM output D/A conversion section 212. Then, music data is converted by the BGM output D/A conversion section 212 into an analog audio signal. The converted signal in turn passes through the BGM mixing control section 209 and is amplified by the amplifier 210 to a predetermined level and loudly output as a voice from the speaker 141 of the handset 14.

The MPU 203 conducts control on various sections of the IP telephone set TA and performs processing on communication with the IP network IPN through software processing in accordance with control programs and various kinds of data stored in the ROM 204 and the RAM 205 respectively. Further, if a sound volume value setting by a user is accepted through the control key 13, the MPU 203 controls a voice input selection control section 215 and an external output selection control section 216 such that the voice input level conversion section 206 and the amplifier 210 adjust a sound volume value to a set volume value. Then, the result is displayed on the display section 11. Note that this display section may utilize lighting or blinking of an LED etc.

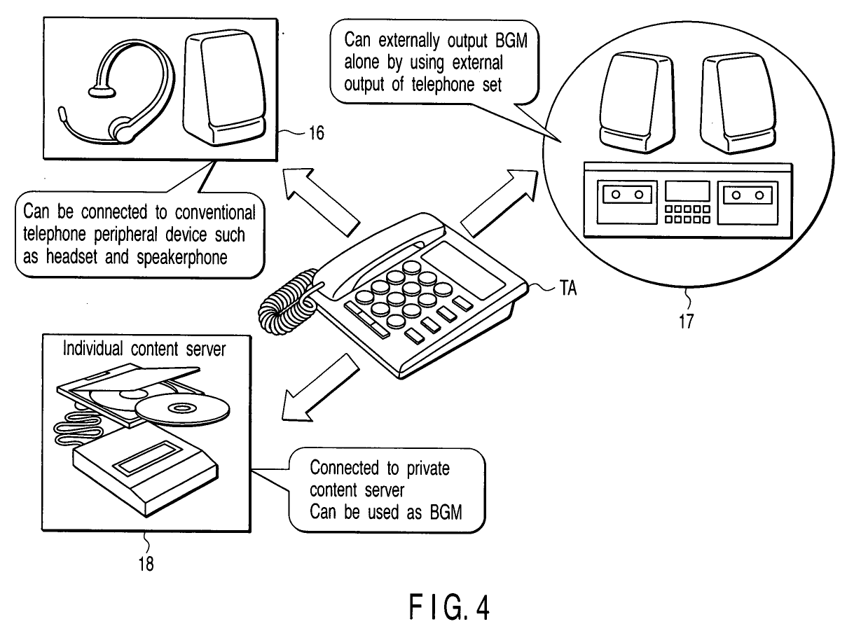

Further, as shown in FIG. 4, a headset 16 can be connected to the IP telephone set TA. That is, a message-transmission audio signal from the headset 16 passes through the voice input level conversion section 213 and is converted by the voice input A/D conversion section 207 into voice data, which is provided to the CODEC DSP 202. On the other hand, voice data destined for the headset 16 is supplied from the CODEC DSP 202 to the voice output D/A conversion section 208 to be converted into an analog audio signal. The converted signal passes through the BGM mixing control section 209 and is amplified by an amplifier 214 to a predetermined level and loudly output as a voice from a speaker of the headset 16.

Note that whether to use the handset 14 or the headset 16 is selectively controlled by the voice input selection control section 215 and the external output selection control section 216 in accordance with a user's input command accepted by the keystroke control section 211.

In addition, in a case where an external device 17 such as a speaker or a stereo deck is connected, BGM data is provided from the BGM output D/A conversion section 212 to an amplifier 217 to be amplified to a predetermined level and then output to the external device 17.

Further, an individual content server 18 such as a CD player can be connected to the above-described IP telephone set TA. That is, BGM data reproduced and output from the individual content server 18 is provided via an external BGM analog input level conversion section 218 to a D/A conversion section 219 to be converted into an analog BGM signal and supplied to the BGM mixing control section 209 or the IP control section 201.

The IP telephone set TA further comprises an external BGM digital input format conversion section 220. If BGM data to be transmitted to the IP telephone set TB is not of a data format that can be handled by the IP telephone set TB, the external BGM digital input format conversion section 220 converts the data format.

Next, processing operations in the above-described system will be described.

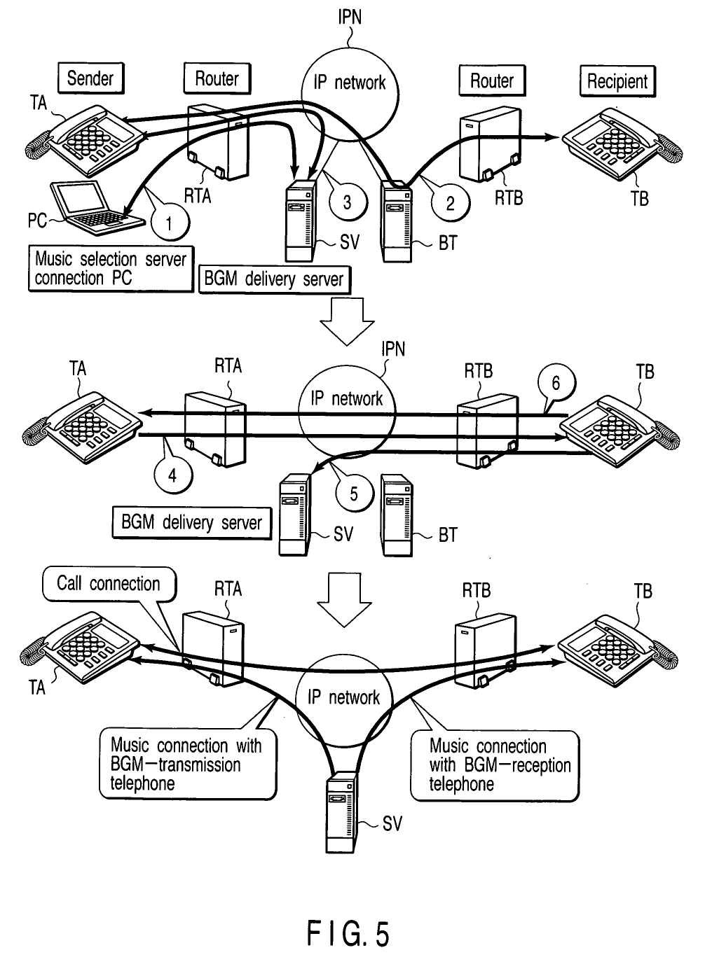

FIG. 5 is a schematic sequence diagram showing operations of transmission and reception of information among the IP telephone set TA, the SIP server BT, the BGM server SV, and the IP telephone set TB. The following will describe a case where a session initiation protocol (SIP) and an SIP-related protocol are used to establish connection among the IP telephone set TA, the IP telephone set TB, and the BGM server SV.

The user downloads a Web screen by connecting to the BGM server SV via the IP network IPN using the personal computer PC. After the connection, he/she selects a music piece to be used as BGM. Specifically, he/she selects it by inputting information such as call contents, and a desired artist, on the Web screen. After the selection is completed, he/she registers the following items to the BGM server SV. Note that information to be registered includes 1: IP telephone number of a transmission side (his/her own), 2: IP telephone number of a reception side (partner), 3: title of a music piece (a plurality of music pieces can be specified), and 4: insertion schedule (see FIG. 5(1)).

Supposed that the user at the IP telephone set TA has performed dial operations to talk over the phone with a user of the IP telephone set TB. Then, a communication establishment request signal is sent from the IP telephone set TA to the SIP server BT. When having received the communication establishment request signal, the SIP server BT calls the destination IP telephone set TB. If the IP telephone set TB has responded to this, the SIP server BT forms voice connection between the IP telephone sets TA and TB (see FIG. 5(2)).

Now it enables the user of the IP telephone set TA to talk over the phone with the user of the IP telephone set TB.

In this case, the user of the IP telephone set TA can press the BGM insertion button 131 at an arbitrary point in time, and does so when he/she uses a BGM insertion function. Then, the BGM insertion button 131 on the IP telephone set TA on the transmission side hoping to insert BGM blinks in orange.

(BGM Server Connection)

The BGM insertion hoping IP telephone set TA on the transmission side, which has confirmed that the voice connection has been established, gives a connection request to the BGM server SV (see FIG. 5(3)). In this case, the BGM insertion button 131 on the transmission-side IP telephone set TA blinks, to indicate they are in connection with each other.

(Authentication by BGM Server SV)

The BGM server SV determines whether or not a user agent of the IP telephone set TA that has requested for connection is an authentic user. The determination involves comparison of a registered IP telephone number to information such as an IP telephone number of the IP telephone set TA requesting for connection.

(Establishment of Connection Between Transmission-Side BGM IP Telephone Set and BGM Server)

If the transmission-side IP telephone set TA is determined to be an authentic user, the BGM server SV establishes broadband music connection between itself and the IP telephone set TA. If a determination error occurs, the BGM insertion button 131 lights in red, to indicate a failure in connection to the BGM server SV.

(Commanding BGM Server Connection to Reception-Side BGM IP Telephone Set)

When having confirmed connection with the BGM server SV, the reception-side IP telephone set TA requests the partner IP telephone set TB to connect to the BGM server SV (see FIG. 5(4)). This connection request is transmitted in a REFER message of the SIR Then, the BGM insertion button 131 on the transmission-side IP telephone set TA blinks in green. The BGM insertion button 131 on the reception-side IP telephone set TB blinks in orange, to indicate that it is in connection with the BGM delivery server.

(Connection Between Reception-Side IP Telephone Set TB and BGM Server SV)

When having received the above-described connection request, the IP telephone set TB gives a connection request to the BGM server SV (see FIG. 5(5)). Then, the BGM insertion button 131 on the IP telephone set TB blinks in green.

(Determination of BGM Delivery Server)

When having been requested for connection from the IP telephone set TB, the BGM server SV searches for registered BGM registration list information in order to confirm that the IP telephone set TB requesting for connection is an authentic IP telephone set. If, as a result of the search, the connection-requesting side (reception-side BGM IP telephone set) is an authentic IP telephone set, broadband music connection is established between the IP telephone set TB and the BGM server. Then, the BGM insertion button 131 on the IP telephone set TB lights in green.

(Establishment of Reception-Side BGM Connection)

When broadband music connection is established between the IP telephone set TB and the BGM server SV, the BGM server SV starts delivery of music to the transmission-side IP telephone set TA and the reception-side IP telephone set TB.

(Notification of Establishment of Reception-Side BGM Connection)

When broadband music connection is established between the reception-side IP telephone set TB and the BGM server SV, the reception-side IP telephone set TB notifies the transmission-side IP telephone set TA of a result of the connection. That is, in the case of normal connection, the BGM insertion button 131 on the transmission-side IP telephone set TA lights in green to produce a voice or a sign tone from the speaker 141 on the side of the sender to indicate completion of BGM connection. In the case of a failure in connection, it blinks in red to produce a voice or a sign tone from the speaker 141 on the side of the sender.

(Establishment of BGM Delivery Connection)

When the above-described procedure is normally completed, BGM delivery connection is established. Call connection is established “between the IP telephone set TA and the IP telephone set TB” and BGM connection is established “between transmit BGM and the BGM server and between the reception-side BGM IP telephone set and the BGM server”.

(BGM Sound Volume Adjustment)

Although BGM is delivered after its sound volume is adjusted on the side of the BGM server in advance, the transmission-side or reception-side IP telephone set TA or TB can arbitrarily adjust the sound volume by using its sound volume adjustment function. In the above, a case has been described where BGM is inserted at the beginning of a call. A sender or a recipient can also operate the IP telephone set TA or TB or the personal computer PC during a call to connect to the BGM server SV, so that BGM can be selected and inserted. After the BGM is selected, when the BGM insertion button 131 on the IP telephone set TA or TB is pressed, operations start to establish connection between the IP telephone set TA demanding the BGM and the partner IP telephone set TB.

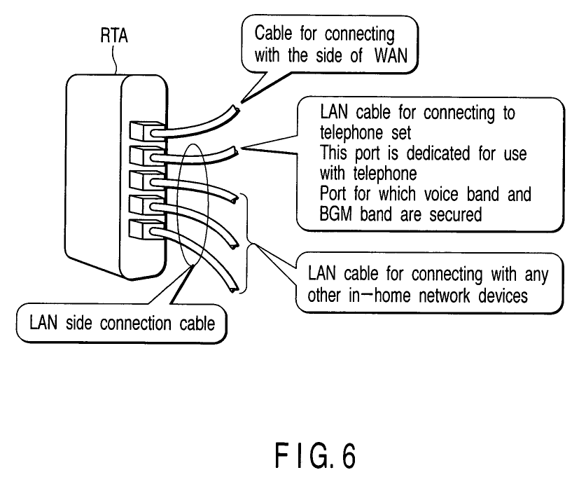

Next, the routers RTA and RTB will be described. FIG. 6 is a structure view of the routers RTA and RTB. Any router whose quality of service (Qos) functions sufficiently in Ipv4 and Ipv6 is expensive. Therefore, to secure frequency bands for the IP telephone sets TA and TB, the routers RTA and RTB are provided with a fixed port for connecting the IP telephone sets TA and TB respectively. The IP telephone sets TA and TB are connected to this specific port to acquire the frequency bands.

As described above, in the first embodiment, when the IP telephone set TA establishes voice connection with the IP telephone sets TB, arbitrary BGM data is downloaded from the BGM server SV on the IP network IPN and BGM connection by way of the BGM server is established between itself and the IP telephone set TB in accordance with response from the IP telephone set TB, so that BGM data desired by the user of the IP telephone set TA is reproduced as sound by the IP telephone set TB.

Therefore, the IP telephone sets TA and TB, none of which has a music source, can have a function to use BGM data as required and also the users of these telephone sets can enjoy hearing atmospheric high-quality BMG during a call. Furthermore, since arbitrary BGM data is downloaded from the BGM server SV on the IP network IPN, it is unnecessary to store all of BGM data assumed to be used in the RAM 205 in the IP telephone set TA, thereby acquiring BGM data easily anytime and anywhere.

Further, according to the first embodiment, the IP telephone sets TA and TB can mute unnecessary BGM by using the sound volume adjustment function. It thus enables a recipient to reproduce only really required BGM data as sound.

Also, in the first embodiment, call connection and BGM connection are established between the IP telephone sets TA and TB. Accordingly, it enables concurrent control of transmission of voice packet and that of BGM data independently of each other, thereby surely performing transmission of voice packets and that of BGM data in such a manner as to avoid mutual influence. Further, since BGM data is transmitted through dedicated BGM connection other than call connection for transmission of voice packets, it is not subject to telephone protocol limitations, that is, a sampling frequency is 8 kHz and a voice frequency band is from 300 Hz to 3.7 kHz. It thus enables the BGM connection to secure a wide frequency band, so that the user can talk over the phone to his/her partner while enjoying music having a higher quality than that of the telephone owing to this wide band. Note that the speech bandwidth of 300 Hz to 3.7 kHz is a frequency band defined in the standards called G.711. In Japan and the United States, G.711 and μ-Law are used. G.711 is a system that achieves transmission rate of 64 kbps through the telephone line by means of pulse code modulation (PCM). More specifically, analog signals of the maximum frequency of 3.4 kHz on telephone line are sampled at 8 kHz, i.e., about twice as high the frequency of the signals. Each sampled segment is represented by 8 bits. On the other hand, μ-Law is a system is one of the schemes of encoding analog audio signals to digital signals by means of PCT. The quantization noise accompanying the PCM encoding is constant, irrespective of the signal frequency. Hence, the signal/noise (S/N) ratio will be inevitably small if the signal amplitude is small. Hence, in G.711, the resolution of quantization is changed in accordance with the signal amplitude. More precisely, signals of large amplitude are reduced (or compressed) in resolution and signals of small amplitude are enhanced in resolution, thus achieving non-linear quantization. In μ-Law, the characteristic of this resolution compressing is determined by using a logarithmical function and is approximated to 15 line plots.

Further, the IP telephone set TA is provided with the external BGM digital input format conversion section 220 to enable converting a data format of BGM data destined for the IP telephone set TB into a data format that can be handled by the IP telephone set TB, so that the BGM data formats can be unified even if the data format varies with each of the IP telephone sets.

### Second Embodiment

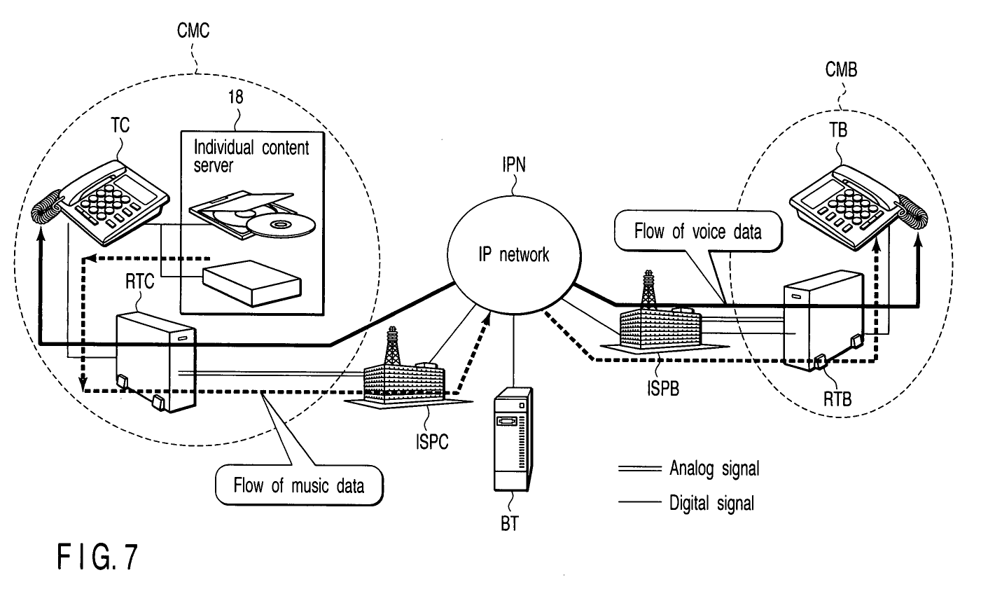

FIG. 7 is a schematic diagram showing a configuration of an IP telephone system in a second embodiment of the present invention, in which CMC indicates a user system. Note that the same components of FIG. 7 as those of FIG. 1 are indicated by the same symbols, and detailed description will not be described.

The user system CMC comprises an IP telephone set TC, an individual content server 18, and a router RTC. The individual content server 18 has a plurality of BGM data stored therein, and in response to a user's input commanding operation, reproduces an arbitrary one item of the BGM data and inputs it to the IP telephone set TC.

The following will describe operations of processing by the above-described system.

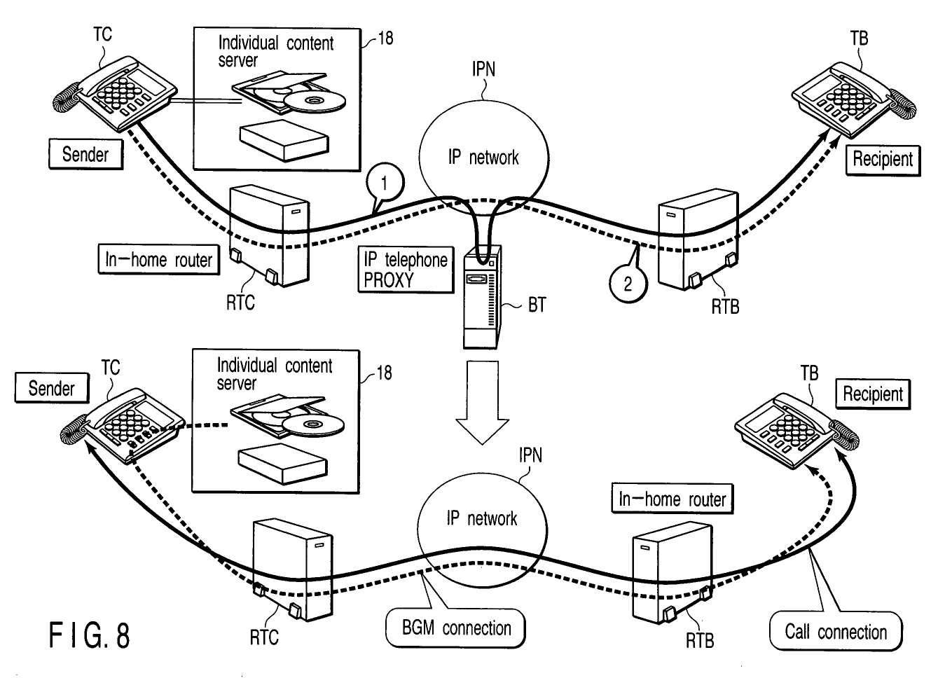

FIG. 8 is a schematic sequence diagram showing operations to transmit and receive information among the IP telephone set TC, a SIP server BT, and an IP telephone set TB. In the following, a case will be described in which a session initiation protocol (SIP) and an SIP-related protocol are used to establish connection between the IP telephone set TC and the IP telephone set TB.

A server-less type BGM IP telephone system has a configuration constituted of the IP telephone set TC, the router RTC, and the private content server 18. BGM to be inserted is delivered from the individual content server 18 to a recipient through his/her IP telephone set TC.

That is, a sender connects the individual content server 18 and the IP telephone set TC to each other. Then, he/she selects his/her desired music from contents stored in the individual content server 18. After the BGM is selected, he/she performs an ordinary IP telephone set operation to establish voice connection by using the IP telephone set TC.

When having confirmed establishment of the voice connection with the IP telephone set TB on the reception side, the IP telephone set TC on the transmission side starts operations to establish BGM-BGM connection.

(Connection with Individual Content Server)

A user selects a music piece to be used as BGM from contents stored in the individual content server 18 and connects an output terminal of the individual content server 18 and the IP telephone set TC to each other.

(Establishment of Voice Connection)

Suppose that the user of the IP telephone set TC has performed transmission to his/her partner IP telephone set TB by using the IP telephone set TC. Then, the SIP server BT establishes voice connection between the IP telephone sets TC and TB as in the case of operations with an ordinary IP telephone (see FIG. 8(1)).

(Establishment of BGM Connection)

When having confirmed establishment of the voice connection between the IP telephone set TC on the transmission side and the IP telephone set TB on the reception side, the IP telephone set TC on the transmission side establishes BGM connection. The IP telephone set TC transmits “Offerer” to the IP telephone set TB on the reception side in order to acquire information of the BGM connection (see FIG. 8(2)). A BGM insertion button 131 on the transmission side blinks in orange, to indicate they are in connection with each other.

(Determination of BGM Connection)

The IP telephone set TC on the transmission side analyzes an answer (Answerer) information from the IP telephone set TB on the reception side, to determine whether or not there is BGM connection that matches connection information supported by a reception BGM IP telephone.

(Establishment of BGM Connection)

If there is matching BGM connection, the BGM insertion button 131 on the IP telephone set TC changes to a mode of lighting in green to indicate that BGM can be inserted. Further, a voice or a sign tone indicative of completion of the BGM connection is produced from the speaker 141 on the side of the sender. Then, a BGM IP telephone button on the side of the recipient changes from a mode of blinking in orange to the mode of lighting in green.

(Insertion of BGM)

When having confirmed establishment of the BGM connection, the sender inputs the BGM from his/her own BGM content server 18 to the IP telephone set TC (reproduction).

(BGM Format Conversion)

In the case of an analog audio input, the transmission-side BGM IP telephone set performs A/D conversion and encoding on it. The encoded data is decoded on the transmission side also and so can be heard through the speaker 141 of the handset 14. A BGM sound volume can be set to an arbitrary volume by a BGM sound volume adjustment function.

(Transmission of BGM Data)

The encoded BGM data is transferred to the reception-side IP telephone set TB through the BGM connection.

(BGM Sound Volume Adjustment by Reception Side)

A BGM sound volume can be set to an arbitrary volume by the BGM sound volume adjustment function of the reception-side IP telephone set TB. The above example has described the case of transmitting an individual BGM content owned by the sender. By connecting an individual content owned by the recipient to an external input of the IP telephone set TB, it also enables an insertion of BGM from the side of the recipient. To input BGM from the side of the recipient, the BGM can be inserted through operations by use of the BGM insertion button 131 on the side of the recipient.

As described above, in the above second embodiment, arbitrary BGM data is input to the IP telephone set TC from the individual content server 18 owned by a user of the IP telephone set TC and transferred from the IP telephone set TC to the call-partner IP telephone set TB via BGM connection over the IP network IPN. Therefore, the user of the IP telephone set TC can select desired BGM from contents stored in the individual content server 18, so that the BGM can be heard by a user of the IP telephone set TB during a call.

### Third Embodiment

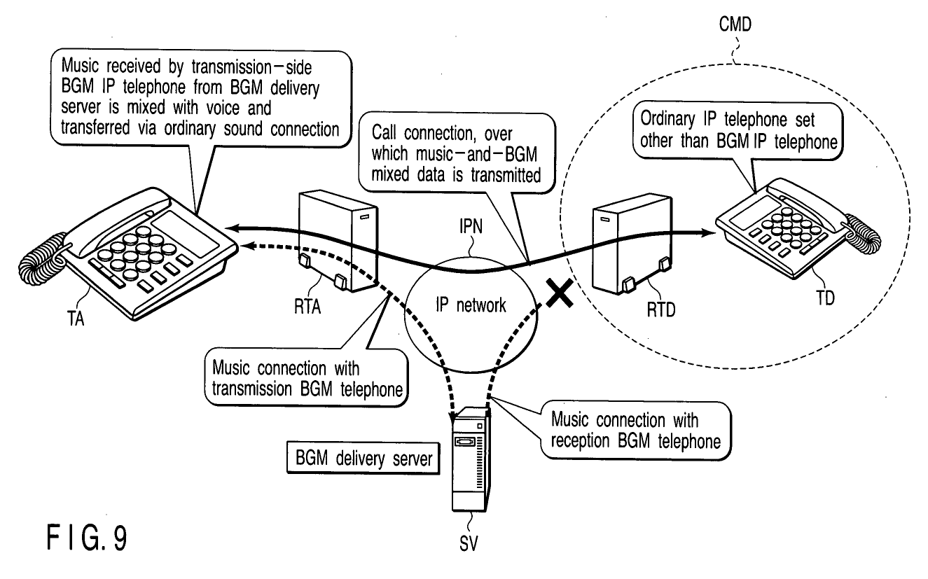

FIG. 9 is a schematic diagram showing a configuration of an IP telephone system in a third embodiment of the present invention, in which CMD indicates a user system. Note that the same components of FIG. 9 as those of FIG. 1 are indicated by the same symbols, and detailed description will not be described.

The user system CMD comprises a IP telephone set TD not mounted with a BGM function and a router RTD.

The following will describe operations of processing by the above-described system.

If a BGM insertion request is transmitted from the IP telephone set TA to the IP telephone set TD, the IP telephone set TD on the reception side notifies the IP telephone set TA on the transmission side of a result of establishment of connection between the telephone set TD and the BGM server SV (in which no response is given from the reception-side telephone set TD in some cases).

If no response is given for a constant lapse of time or a failure is notified of in response to a BGM server connection request, the BGM insertion button 131 lights in red on the IP telephone set TA that has requested for insertion of BGM. Further, it is notified by voice that the reception side is not an IP telephone set that can accommodate BGM. Then, a sender presses the BGM insertion button 131 again to notify a BGM IP telephone that it has confirmed with the telephone set about the state.

(Operations to Insert BGM)

The sender, if he/she wishes to insert BGM with a telephone quality, presses a mixing button 132 on the IP telephone set TA.

(Analog Mixing Processing on BGM and Received Voice)

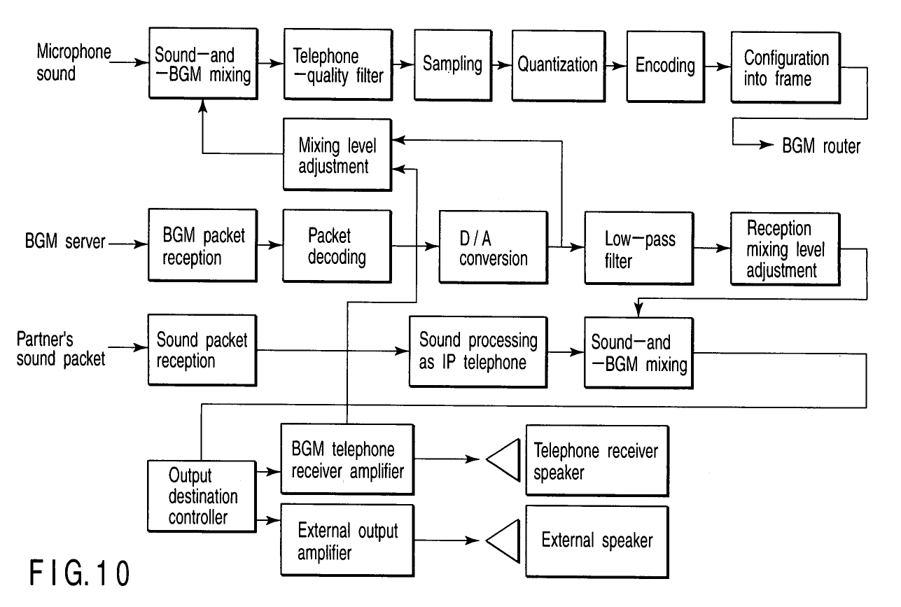

FIG. 10 is a diagram showing a flow of mixing processing by the IP telephone set TA. The IP telephone set TA, when the mixing button 132 is pressed on it, demodulates BGM acquired from the BGM server SV and performs D/A conversion. The converted analog BGM data is input to a BGM-and-received voice analog mixing level adjuster. The mixing level adjuster automatically adjusts a level to be output from the speaker 141 of the handset 14. Further, by manually changing settings of the mixing level adjuster, a level of BGM can be set to an arbitrary value.

(Analog Mixing Processing on BGM and Microphone Voice)

After having undergone D/A conversion, the BGM data received from the BGM server SV is input to a microphone input voice-and-BGM mixing level adjuster. The microphone input voice-and-BGM mixing level adjuster adjusts the D/A converted BGM data to a BGM level based on a level of a microphone input volume.

(Analog Mixing Processing on BGM and Microphone Input Voice)

An analog BGM signal whose level adjustment has been completed by the microphone input voice-and-BGM mixing level adjuster is input to a “voice-and-BGM mixer”. A microphone input voice and BGM are mixed with each other by the “voice-and-BGM mixer”.

(Conversion to Telephone Data)

The mixed data of the voice and the BGM is converted by a telephone sound quality filter converter into a telephone quality in accordance with the ordinary IP telephone voice conversion procedure.

(Delivery of Mixed Data)

The converted microphone input voice-and-BGM mixed data is put into an LAN packet frame. When completely put into a frame, the data is transmitted to an in-home router. Although the present embodiment has exemplified a case where they are subject to analog mixing, they can be mixed digitally.

As described above, in the third embodiment, even if a call partner uses the telephone set TD that cannot accommodate a BGM IP telephone and BGM connection cannot be established, the IP telephone set TA is configured to combine a voice packet and BGM data and transmit them to the telephone set TD by using voice connection.

Therefore, it enables the user to enjoy hearing music that matches a call during a phone call, at a telephone quality though, irrespective of a type of a telephone set used.

### Fourth Embodiment

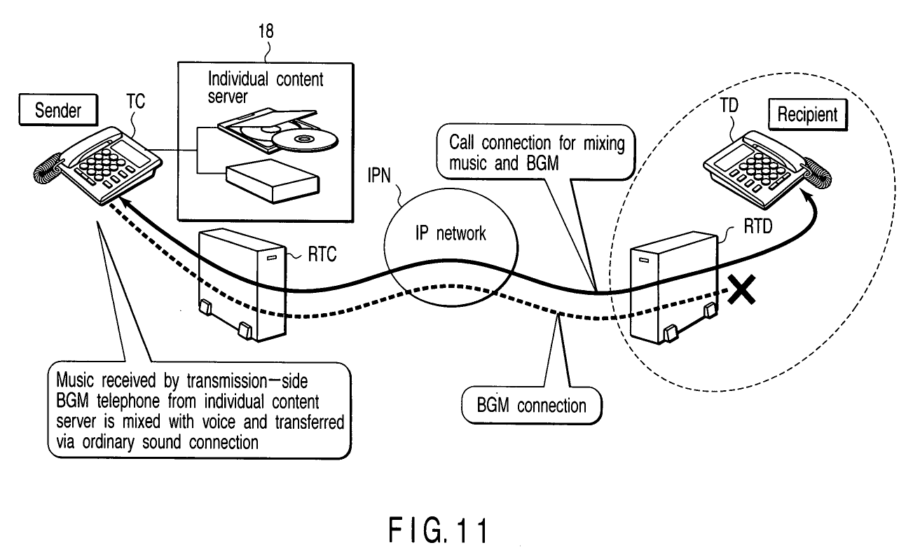

FIG. 11 is a schematic diagram showing a configuration of an IP telephone system in a fourth embodiment of the present invention. Note that the same components of FIG. 11 as those of FIG. 9 are indicated by the same symbols, and detailed description will not be described.

(Failure in Establishment of BGM Connection)

Suppose that a BGM insertion request has been transmitted from the IP telephone set TC to the telephone set TD. If the BGM insertion button 131 lights in red without changing from a mode of blinking in orange to a mode of lighting in green, it indicates that a relevant telephone is of a non-BGM IP type that cannot insert BGM. Further, the IP telephone set TC on the side of transmission notifies by voice that the side of a partner is not a BGM IP telephone. A sender then presses the BGM insertion button 131 again to notify the telephone set TD that it has confirmed with the telephone set TD about the state.

(Mixing at Server-Less Type BGM IP Telephone)

The sender presses a mixing button 132 on the IP telephone set TC if he/she wishes to insert BGM at a telephone quality.

(Starting of Mixing Processing at Server-Less Type BGM IP Telephone)

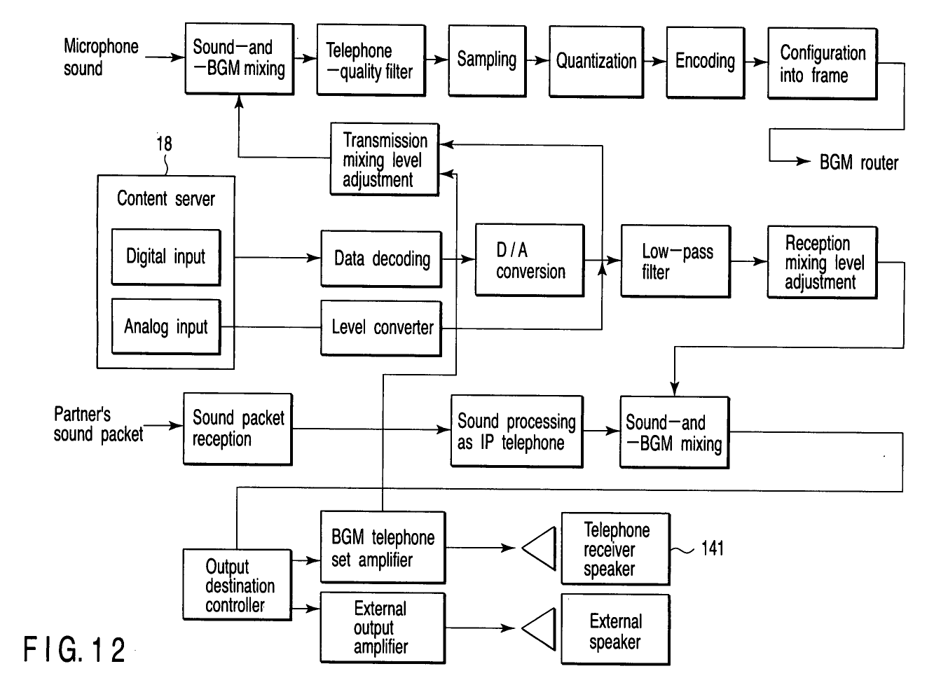

FIG. 12 is a diagram showing a flow of mixing processing by the IP telephone set TC. When the mixing button 132 on the IP telephone set TC is pressed, reproduction by an individual content server 18 starts.

(Determination of Input Contents)

By a format (digital or analog format) of BGM data from the individual content server 18, the IP telephone set TC determines its input format.

[In the Case of Digital Content Input]

(Demodulation and Amplification)

BGM acquired from the individual content server 18 is demodulated and subject to D/A conversion. The converted analog data is amplified by a telephone receiver's speaker amplifier of an amplifier 210.

(Mixing with Telephone Receiver Sound)

The D/A converted BGM data is input to a mixing level adjuster. The mixing level adjuster amplifies the D/A converted BGM data to an automatically set BGM level based on a level of a received voice. Further, the BGM mixing level can be adjusted arbitrarily through manual operations. An output destination is selected using an output controller.

(Mixing of Microphone Input Voice and BGM)

The D/A converted BGM data undergoes automatic BGM mixing level adjustment by the mixing level adjuster. An analog BGM signal after completion of mixing level adjustment is input to a voice-and-BGM mixer. A microphone input voice and BGM are properly mixed with each other by the “microphone input voice-and-BGM mixer”.

(Conversion of Transmit Data Format)

Mixed data obtained by thus mixing the microphone input voice and the BGM is converted to a telephone quality in accordance with the ordinary IP telephone voice conversion procedure.

(Delivery of Mixed Data of Voice and BGM)

The mixed data thus converted is put into an LAN packet frame. When completely put into a frame, the data is transmitted to the in-home router RTC.

[In the Case of Analog Content Input]

(Input Level Conversion)

The input analog data has its level converted by a level converter. The converted data is input to a transmission mixing level adjuster.

(Mixing with Telephone Receiver Sound)

The D/A converted BGM data is input to the mixing level adjuster. The mixing level adjuster amplifies the D/A converted BGM data to an automatically set BGM level based on the level of the received voice. Further, the BGM mixing level can be adjusted arbitrarily through manual operations. An output destination is selected using an output controller.

(Mixing of Microphone Input Voice and BGM)

The D/A converted BGM data undergoes automatic BGM mixing level adjustment by the mixing level adjuster. An analog BGM signal after completion of mixing level adjustment is input to the voice-and-BGM mixer. The microphone input voice and the BGM are properly mixed with each other by the “microphone input voice-and-BGM mixer”.

(Conversion of Transmit Data Format)

Mixed data obtained by thus mixing the voice and the BGM is converted to a telephone quality in accordance with the ordinary IP telephone voice conversion procedure.

(Delivery of Mixed Data of Voice and BGM)

The mixed data thus converted is put into an LAN packet frame. When completely put into a frame, the data is transmitted to the in-home router RTC. Although the present embodiment has exemplified analog mixing between a microphone input voice and BGM and between a received voice and BGM, they can also be mixed digitally.

As described above, even the fourth embodiment has almost the same functions and effects as the above-described third embodiment and enables a user of the IP telephone set TC to select his/her desired BGM from the individual content server 18, so that a user of the call partner telephone set TD can listen to the BGM.

### Fifth Embodiment

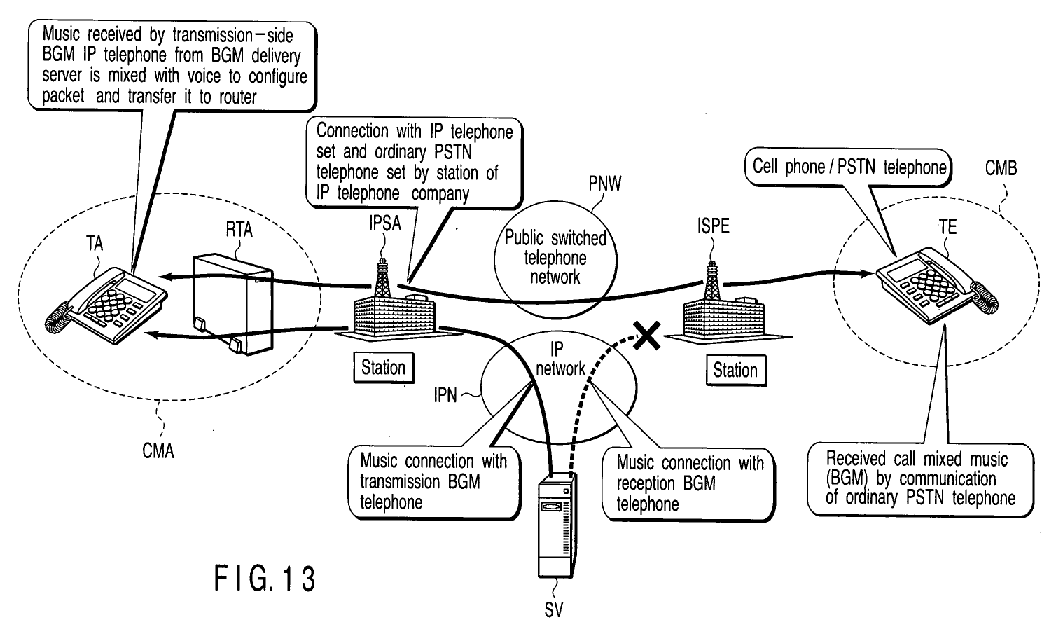

FIG. 13 is a schematic diagram showing a configuration of an IP telephone system in a fifth embodiment of the present invention, in which CME indicates a user system. Note that the same components of FIG. 13 as those of FIG. 1 are indicated by the same symbols, and detailed description will not be described.

The user system CME comprises a telephone set TE and a router RTE. The telephone set TE is either an ordinary PSTN telephone or a cellular telephone.

The telephone set TE is connected to a public switched telephone network PNW via a station ISPE. The public switched telephone network PNW is connected to the IP network IPN by the public-telephone/IP-telephone switchboard installed in the station ISPE. Further, the public switched telephone network PNW is connected to the router of the user-system CMA.

The following will describe operations of processing by the above-described system.

(Procedure for Inserting BGM)

The IP telephone set TA establishes voice connection with the telephone set TE as in the case of the ordinary cell phone or a PSTN telephone set.

(Processing to Establish BGM Connection)

When having confirmed establishment of the voice connection, the IP telephone set TA then requests a BGM server SV for connection. The BGM insertion button 131 blinks in orange to indicate that they are in connection with each other.

(Determination of BGM Server)

The BGM server SV determines whether or not a user agent of the IP telephone set TA requesting for connection is an authentic user. The determination involves comparison of a registered IP telephone number to an IP telephone number of the IP telephone set TA requesting for connection.

(Authentication by BGM Server SV)

If the IP telephone set TA, which is a sender, is decided by the BGM server SV to be an authentic user, broadband music connection is established between the BGM server SV and the IP telephone set TA. If the decision results in an error, the BGM insertion button 131 on the IP telephone set TA lights in red to indicate a failure in connection to the server.

(Determination of Being Non-BGM IP Telephone)

When having confirmed establishment of connection between the BGM server SV and the IP telephone set TA, the IP telephone set TA requests the reception-side telephone set TE to connect to the BGM server SV. If the telephone number is determined not to be an IP telephone number but a number of a cell phone or a PSTN telephone, the BGM insertion button 131 lights in red.

(Notification of Recipient Telephone)

When the BGM insertion button 131 lights in red on the IP telephone set TA, the sender is notified by the IP telephone set TA-operated voice that his/her partner is not a BGM IP telephone. The sender presses the BGM insertion button 131 again to notify the telephone set that he/she has confirmed the state.

(Operations to Insert BGM to Non-BGM Accommodating Telephone)

The sender, if he/she wishes to insert BGM at a telephone quality, presses a mixing button 132 on the IP telephone set TA.

(Analog Mixing Processing on BGM and Received Sound)

If the mixing button 132 is pressed on the IP telephone set TA, BGM acquired from the BGM server SV is decoded and subject to D/A conversion. The converted analog BGM data is input to a BGM-and-received sound analog mixing level adjuster. The mixing level adjuster automatically adjusts a level to be output from a telephone receiver speaker. Further, by manually changing settings of the mixing level adjuster, a level of BGM can be set to an arbitrary value.

(Analog Mixing Processing on BGM and Microphone Voice)

After having undergone D/A conversion, the BGM data received from the BGM server SV is input to a microphone input voice-and-BGM mixing level adjuster. The microphone input voice-and-BGM mixing level adjuster adjusts the D/A converted BGM data to a BGM level based on a level of a microphone input volume.

(Analog Mixing Processing on BGM and Microphone Input Voice)

An analog BGM signal whose level adjustment has been completed by the microphone input voice-and-BGM mixing level adjuster is input to a “voice-and-BGM mixer”. A microphone input voice and BGM are mixed with each other by the “voice-and-BGM mixer”.

(Conversion to Telephone Data)

The mixed data of the voice and the BGM is converted by a telephone sound quality filter converter into a telephone quality in accordance with the ordinary IP telephone voice conversion procedure.

(Delivery of Mixed Data)

The converted microphone input voice-and-BGM mixed data is put into an LAN packet frame. When completely put into a frame, the data is transmitted to the in-home router RTA. Although the present embodiment has exemplified a case where they are subject to analog mixing, they can be mixed digitally.

As described above, in the fifth embodiment, even if a call partner is the telephone set TE such as a cell phone or an existing PSTN telephone and BGM connection cannot be established, the IP telephone set TA is configured to combine a voice packet and BGM data and transmit them to the telephone set TE by using voice connection established on the public telephone network PNW, so that a user of the telephone set TE can enjoy listening to music that matches a call, at a telephone quality though.

### Sixth Embodiment

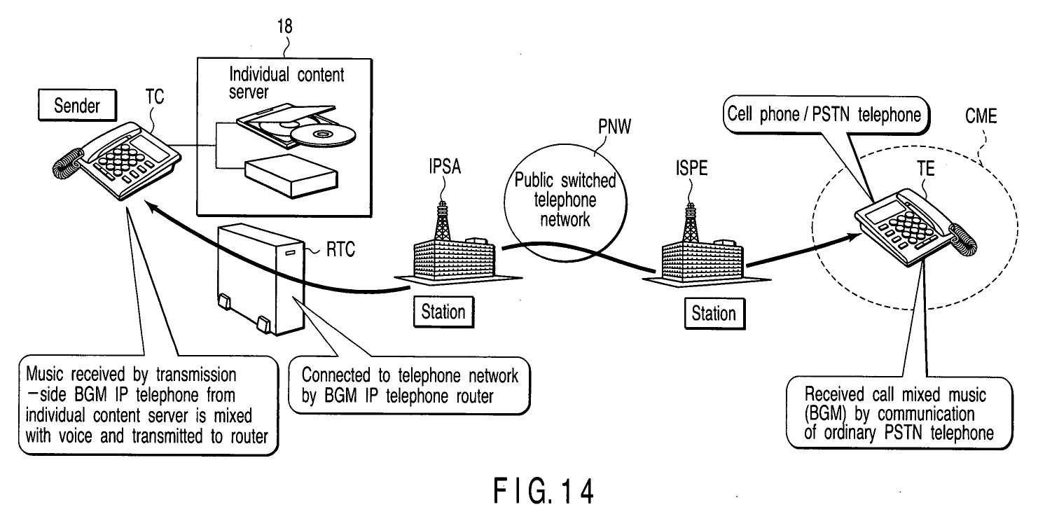

FIG. 14 is a schematic diagram showing a configuration of an IP telephone system in a sixth embodiment of the present invention. Note that the same components of FIG. 14 as those of FIGS. 7 and 13 are indicated by the same symbols, and detailed description will not be described. The telephone set TC is connected to the public switched telephone network PNW via a router and a station IPSC.

(Connection with Individual Content Server)

A user of the IP telephone set TC selects a music piece to be used as BGM from contents stored in the individual content server 18 and connects an output of the individual content server 18 and the IP telephone set TC.

(Preparation for Inserting BGM)

In the case of using a BGM insertion function, the user of the IP telephone set TC presses the BGM insertion button 131 and sends a transmission request to his/her partner telephone set TE. Then, the BGM insertion button 131 lights in orange to indicate preparation for connection.

(Establishment of Voice Connection)

As in the case of ordinary PSTN telephone operations, the IP telephone set TC establishes voice connection between a sender and a recipient.

(Determination of BGM Connection)

When it is confirmed that voice connection has been established between the transmission-side IP telephone set TC and the reception-side telephone set TE, the transmission-side IP telephone set TC establishes BGM connection. When having decided that the telephone set TE is a cell phone or a PSTN telephone, the IP telephone set TC lights the BGM insertion button 131 in red. Further, it is notified by voice that the partner is not a BGM IP telephone.

(Confirmation of Connection with Non-BGM IP Telephone)

The sender presses the BGM insertion button 131 on the IP telephone set TC again to notify the telephone set that he/she has confirmed the state.

(Insertion of BGM to Non-BGM IP Telephone)

The sender, if he/she wishes to insert BGM at a telephone quality, presses a mixing button 132 on the IP telephone set TC.

(Mixing Operations)

The user of the IP telephone set TC presses the mixing button 132 to start reproduction by the individual content server 18.

(Decision of External Input)

By a format (digital or analog format) of BGM data from the individual content server 18, the IP telephone set TC determines its input format.

[In the Case of Digital Content Input]

(Demodulation and Amplification)

BGM acquired from the individual content server 18 is demodulated and subject to D/A conversion. The converted analog data is amplified by a telephone receiver's speaker amplifier.

(Mixing with Telephone Receiver Sound)

The D/A converted BGM data is input to a mixing level adjuster. The mixing level adjuster amplifies the D/A converted BGM data to an automatically set BGM level based on a level of a received voice. Further, the BGM mixing level can be adjusted arbitrarily through manual operations. An output destination is selected using an output controller.

(Mixing of Microphone Input Voice and BGM)

The D/A converted BGM data undergoes automatic BGM mixing level adjustment by the mixing level adjuster. An analog BGM signal after completion of mixing level adjustment is input to a voice-and-BGM mixer. A microphone input voice and BGM are properly mixed with each other by the “microphone input voice-and-BGM mixer”.

(Conversion of Transmit Data Format)

Mixed data obtained by thus mixing the microphone input voice and the BGM is converted to a telephone quality in accordance with the ordinary IP telephone voice conversion procedure.

(Delivery of Mixed Data of Voice and BGM)

The mixed data thus converted is put into an LAN packet frame. When completely put into a frame, the data is transmitted to the in-home router RTC.

[In the Case of Analog Content Input]

(Input Level Conversion)

The input analog data has its level converted by a level converter. The converted data is input to a transmission mixing level adjuster.

(Mixing with Telephone Receiver Sound)

The-post D/A conversion BGM data is input to the mixing level adjuster. The mixing level adjuster amplifies the D/A converted BGM data to an automatically set BGM level based on the level of the received voice. Further, the BGM mixing level can be adjusted arbitrarily through manual operations. An output destination is selected using an output controller.

(Mixing of Microphone Input Voice and BGM)

The D/A converted BGM data undergoes automatic BGM mixing level adjustment by the mixing level adjuster. An analog BGM signal after completion of mixing level adjustment is input to the voice-and-BGM mixer. The microphone input voice and the BGM are properly mixed with each other by the “microphone input voice-and-BGM mixer”.

(Conversion of Transmit Data Format)

Mixed data obtained by thus mixing the voice and the BGM is converted to a telephone quality in accordance with the ordinary IP telephone voice conversion procedure.

(Delivery of Mixed Data of Voice and BGM)

The mixed data thus converted is put into an LAN packet frame. When completely put into a frame, the data is transmitted to the in-home router RTC. Although the present embodiment has exemplified analog mixing between a microphone input voice and BGM and between a received voice and BGM, they can also be mixed digitally.

As described above, even a sixth embodiment has almost the same functions and effects as the above-described fifth embodiment.

### Other Embodiments

Note that the present invention is not limited to the above-described embodiments. For example, although the above embodiments have been described with reference to an example where BGM is transmitted to a call partner, it may be replaced with jazz or rock music.

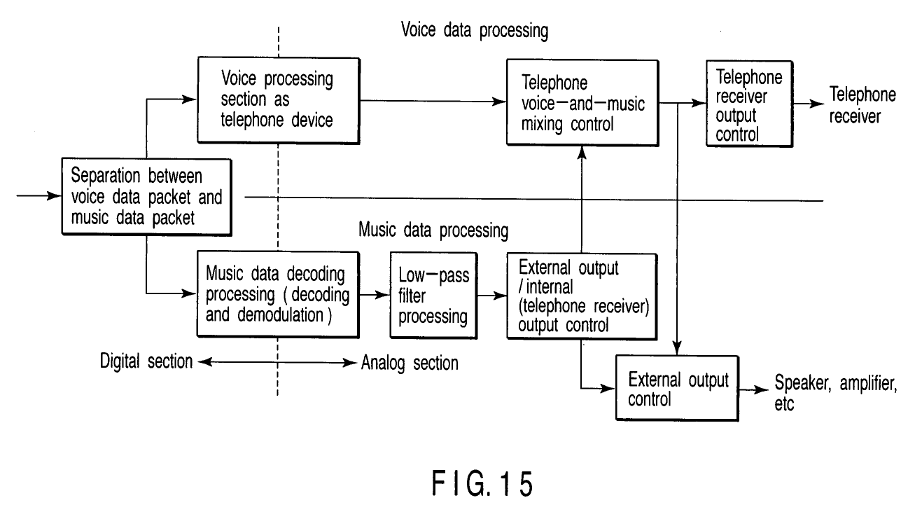

Further, the above first and second embodiments may be configured to mix a telephone voice and BGM or music with each other. Depending on a point of mixing by the BGM mixing control section 209, BGM-and-music data may lose its high sound quality. To solve this problem, a BGM IP telephone performs mixing control processing such as shown in FIG. 15 after the conventional telephone voice processing to maximize high-quality characteristics of BGM-and-music data in a telephone receiver. Consequently, a telephone voice and BGM or music can be mixed with each other without damaging their qualities.

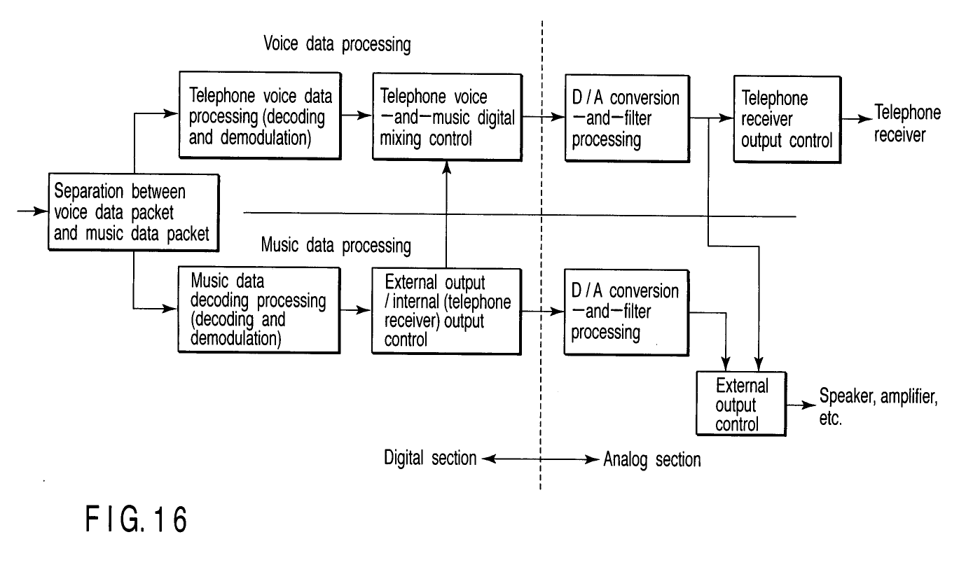

On the other hand, if BGM-and-music data is processed by the same processing system as that of a telephone, the data passes through a band pass filter having a telephone quality of about 4.1 kHz (frequency passband: 300 Hz to 3.7 kHz), so that its high-frequency sound range is cut off. Therefore, a BGM IP telephone set performs telephone voice processing and BGM-and-music processing separately from each other. By mixing a telephone voice and BGM or music at the BGM mixing section 209 at a final stage after completion of analog conversion, conversion noise is prevented from flowing out, thereby reproducing clear sound. Since a voice and BGM are digitized in the BGM IP telephone, a digital mixing method such as shown in FIG. 16 may be possible.

Besides, any other configurations of the IP telephone system, types and configurations of the telephone set, procedures for transmitting BGM data, and the like may be implemented in a variety of modifications without departing from the gist of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system which performs communication by establishing communication connection between a first telephone terminal and a second telephone terminal of a plurality of telephone terminals connected to a communication network over which a voice packet is transmitted, wherein
the first telephone terminal comprises:
an acquisition unit to selectively acquire arbitrary music data from among a plurality of different music data;
a request transmitter which transmits a reception request for the music data to the second telephone terminal via the communication network, when the music data is acquired; and
a data transmitter which transmits the music data to the second telephone terminal via the communication network, when a response to transmission of the reception request is returned from the second telephone terminal; and
the second telephone terminal comprises a reproducer which reproduces as sound the voice data sent from the first telephone terminal, when a reception request for the music data has arrived from the first telephone terminal via the communication network.

2. The telephone system according to claim 1, wherein the acquisition unit acquires arbitrary music data by communication with a music provider server which manages said plurality of music data on the communication network.

3. The telephone system according to claim 1, wherein the acquisition unit acquires arbitrary music data from a music recorder which records said plurality of music data.

4. The telephone system according to claim 1, wherein the reproducer is configured to adjust a sound volume of the music data to be reproduced as sound.

5. The telephone system according to claim 1, wherein the data transmitter establishes music connection different from the communication connection with the second telephone terminal in response to a response from the second telephone terminal, and transmits the music data to the second telephone terminal via the music connection.

6. The telephone system according to claim 2, wherein
the request transmitter includes in the reception request a connection request for the music provider server for reception of the music data and transmits them to the second telephone terminal, and
when the connection request is received, the reproducer establishes music connection different from the communication connection with the music provider server in accordance with the connection request, and receives the music data from the music provider server to reproduce the music data as sound.

7. The telephone system according to claim 1, wherein, when the second telephone terminal is different in type from the first telephone terminal in response to a response from the second telephone terminal to delivery of the reception request, the data transmitter combines the music data with the voice packet and transmits the combined data to the second telephone terminal via the communication connection.

8. A telephone terminal apparatus for use in a telephone which performs communication by establishing communication connection between a first telephone terminal and a second telephone terminal of a plurality of telephone terminals connected to a communication network over which a voice packet is transmitted, the telephone terminal unit being used as the first telephone terminal, the telephone terminal apparatus comprising:
an acquisition unit to selectively acquire arbitrary music data from among a plurality of different music data;
a request transmitter which transmits a reception request for the music data to the second telephone terminal via the communication network, when the music data is acquired; and
a data transmitter which transmits the music data to the second telephone terminal via the communication network, when a response to transmission of the reception request is returned from the second telephone terminal.

9. The telephone terminal apparatus according to claim 8, wherein the acquisition unit acquires arbitrary music data by communication with a music provider server which manages a plurality of music data on the communication network.

10. The telephone terminal apparatus according to claim 8, wherein the acquisition unit acquires arbitrary music data from a music recorder which records a plurality of music data.

11. The telephone terminal apparatus according to claim 8, wherein the data transmitter establishes music connection different from the communication connection with the second telephone terminal in response to a response from the second telephone terminal, and transmits the music data to the second telephone terminal via the music connection.

12. The telephone terminal apparatus according to claim 9, wherein the request transmitter includes in the reception request a connection request for the music provider server for reception of the music data and transmits them to the second telephone terminal.

13. The telephone terminal apparatus according to claim 8, when the second telephone terminal is different in type from the first telephone terminal in response to a response from the second telephone terminal to delivery of the reception request, wherein the data transmitter combines the music data with the voice packet and transmits the combined data to the second telephone terminal via the communication connection.

14. The telephone terminal apparatus according to claim 8, wherein the data transmitter comprises converter which converts the music data into a data format which enables the music data to be reproduced as sound by the second telephone terminal, in response to a response from the second telephone terminal to delivery of the reception request.

15. A telephone terminal apparatus for use in a telephone system which performs communication by establishing communication connection between a first telephone terminal and a second telephone terminal of a plurality of telephone terminals connected to a communication network over which a voice packet is transmitted, the telephone terminal apparatus being used as the second telephone terminal, the telephone terminal apparatus comprising a reproducer which reproduces as sound the voice data sent from the first telephone terminal, when a reception request for the music data has arrived from the first telephone terminal via the communication network.

16. The telephone terminal apparatus according to claim 15, when a connection request for a music provider server for reception of the music data is included in the reception request, wherein the reproducer establishes music connection different from the communication connection with the music provider server in accordance with the connection request, and receives the music data from the music provider server to reproduce the music data as sound.

17. The telephone terminal apparatus according to claim 15, wherein the reproducer is configured to arbitrarily adjust a sound volume of the music data to be reproduced as sound.
